(19) United States
(12) Patent Application Publication
(10) Pub. No.: US 2001/0034644 A1
(43) Pub. Date: Oct. 25, 2001

(54) Affiliate dissemination method and system

(76) Inventors: Shay Anavi, Bene-Brak (IL); Eli Shaham, Tel-Aviv (IL)

Correspondence Address: BAKER & BOTTS, 30 ROCKEFELLER PLAZA, NEW YORK, NY, 10112

(21) Appl. No.: 09/725,012

(22) Filed: Nov. 29, 2000

(30) Foreign Application Priority Data
Nov. 29, 1999 (IL) 133208

(51) Int. Cl. G06F 17/60

(52) U.S. Cl. 705/14; 705/26; 705/39

(57) ABSTRACT

A method for effecting affiliate e-commerce. At least one virtual store interested in promoting products or services or web-pages via an affiliate method is provided. A plurality of affiliates are provided, each having access to an e-mail system, with an agent software which adds promotional material relating to the virtual stores to their e-mail signature, or appends such material to outgoing E-mail messages generated by them. Link information in the promotional material is provided, to a joint web server suitable to redirect a web surfer from it to one or more web pages, as well as information in the promotional material, that is suitable to identify the affiliate who has disseminated it. When a remuneration is received from a virtual store for a referral, a portion of such remuneration is credited to one or more of the affiliates.

### FIELD OF THE INVENTION

The present invention relates to a method and system for carrying out electronic commerce in an affiliated mode

### BACKGROUND OF THE INVENTION

Electronic commerce (e-commerce) is already widespread nowadays, and its use is expected to increase constantly. One way of conducting e-commerce is to enter in a so-called affiliate program, whereby a site engaging in e-commerce (the affiliate program web site) affiliates a plurality of other sites. This affiliation, in practice, requires that a banner or other link to the main site be placed on each affiliated site, When a customer reaches the main site through one of the affiliated sites, his origin is known, and if the customer makes a purchase, the affiliated site from which he reached the site where the purchase was carried out is rewarded.

The drawback of this system is that, in order to participate in such programs as an affiliate, it is necessary to possess a web site. Additionally, many web sites are scarcely visited, and therefore cannot generate a substantial and rewarding volume of business. Moreover, this system does not make any use of the most common service of the web—the electronic mail (E-mail).

It is therefore clear that it would be highly desirable to be able to provide a method and system by which persons not owning a web site can participate in e-commerce affiliate programs.

It is an object of the present invention to provide such a method and a system by which individuals can participate in associate programs, without the need for a web site.

It is another object of the present invention to provide a method and a system by which the signature file of E-mail is used as an advertising/promotion/recommendation vehicle.

It is another object of the invention to provide a method and a system by which the signature file of E-mail is used as an affiliation channel.

It is yet another object of the invention to provide a method and a system by which the signature file of E-mail is used as a means of producing income.

It is a further object of the present invention to provide a method and a system by which individuals can participate in associate programs, by means of an E-mail signature file,

It is still another object of the invention to provide a method which permits an increase the volume of business in e-commerce.

Other purposes and advantages of this invention will become apparent as the description proceeds.

### SUMMARY OF THE INVENTION

The present invention is directed to a method for effecting affiliate e-commerce. One or more virtual stores (by “virtual store”, we mean a web site which offers goods or services to the public), interested in promoting products or services or web-pages via an affiliate method, and a plurality of affiliates connected to a joint server, The affiliates have access to an e-mail system, with an agent software which adds promotional material, which may be a signature of e-mail, relating to the virtual stores to their e-mail signature, or appends such material to outgoing E-mail messages generated by them. The promotional material comprises link information to the joint web server, which is suitable to redirect a web surfer from it to one or more web pages. The promotional material, also comprises information suitable to identify the affiliate who has disseminated it. When a remuneration is received from a virtual store for a referral, a portion of such remuneration is credited to one or more of the affiliates, The joint web server may be registered as an affiliate in another joint web server connected to at least another different virtual store, The affiliates may be rewarded according to the purchase and/or according to the times the recipients entered to on-line stores due to the e-mail received from the affiliates, Alternatively, the affiliates are rewarded in a manner selected from fixed and/or differential payments, discount on purchase of goods or services, or coupons for participation in a lottery. Preferably, the web sites may sell goods, promote ideas and/or nominees or provide advertising information.

The present invention is also directed to a system for effecting affiliate e-commerce, which comprises:

at least one joint web server which is affiliated with one or more sites engaging in e-commerce;

one or more affiliates having a client software installed, such that promotional material is added to their e-mail signature, the promotional information comprising data relative to the virtual store and link information suitable to direct any person from the promotional information to the joint web server; and

at least one virtual store providing the promotional material.

Preferably, the promotional information comprises one or more image(s), and/or one or more web link(s).

### BRIEF DESCRIPTION OF THE DRAWINGS

All the above and other characteristics and advantages of the invention will be better understood through the following illustrative and non-limitative description of preferred embodiments thereof, with reference to the appended drawings, wherein,

FIG. 1 schematically shows an E-mail message sent from an affiliate, according to a preferred embodiment of the invention;

FIG. 2 schematically illustrates the activities performed on an affiliate program, according to another preferred embodiment of the invention; and

FIG. 3 illustrates the process of constructing a signature file using the agent software, according to a preferred embodiment of the invention.

### DETAILED DESCRIPTION OF PREFERRED EMBODIMENTS

According to a preferred embodiment of the invention, a person wishing to participate in an affiliate program as an affiliate registers with the Personal Affiliate Program and becomes an “Personal Affiliate”. Then the Personal Affiliate must use a so-called Client Software to compose a signature file which contains information about the virtual stores or products or just Web pages he would like to promote. The client software may be downloaded from the Personal Affiliate Program Web Site (PAPWS) or delivered to him, e.g., as an attachment to an E-mail message. This software, which may be an executable object, a link to a web site or even a combination of both, is used for two purposes: to collect links/banners to Web pages which the Personal Affiliate would like to promote, and to compose a signature file from those links/banners according to the instructions given by the Personal Affiliate Program. The software then adds this file (which may be an HTML file) to the e-mail signature of the Personal Affiliate When a recipient receives an e-mail bearing such promotional information, he may click one of the links/banners and be taken to the relevant site. If a purchase is effected or any other commerce transaction, a reward is due from the seller, which has to be distributed between the affiliate and the PAPWS.

The affiliate to the various e-commerce programs is not the recipient, but rather the Personal Affiliate Program (PAP). Therefore, any recipient reaching the virtual store by clicking on the e-mailed banner will do so through the Personal Affiliate Program Web Site (PAPWS). The virtual store will thus identify the PAPWS as the referrer of the customer, and will pay the due remuneration to it, The PAPWS, according to one preferred embodiment of the invention, keeps track of the transaction and is therefore capable to identify the Personal Affiliate which initiated the first e-mail, and therefore to remunerate him.

According to another preferred embodiment of the invention, remuneration of the affiliate by the PAPWS is not effected on a transaction basis, but rather on the basis of profit distribution schemes, such a scheme based on the number of entrances to given sites, the number of “clicks” by a referred surfer in a given site, or any other suitable scheme.

Thus, a client-server situation exists between the users and the Personal Affiliate Program Web Site (PAPWS), where the PAPWS functions as the facade for a plurality of users, and provides the referral services as well as the distribution of the remuneration to the various users. Thus every person and organization involved gains from this arrangement: the virtual stores increase the volume of traffic and the sales, but decrease the volume of administrative work involved in remunerating the various affiliates, since this is taken care of by the Affiliation Program, while the users may join in the e-commerce Affiliate Program and make a profit, without the need to have a web site.

A common scenario regarding the Affiliate Program is as follows:

Registration:

The Personal Affiliate Program performs a registration procedure at virtual stores.

The Personal Affiliates perform a registration procedure as well, During the registration procedure the details of the Affiliate (such as name, address, bank account etc.) are sent to the Personal Affiliate Program (PAP) and are registered in a suitable database. As a result of the registration procedure, the Personal Affiliate gets a unique ID.

The Personal Affiliate receives or downloads a Client Software.

Collecting the links/banners:

The Personal Affiliate browses the Internet. Whenever he finds a Web page that he would like to promote, he can drag its link/image and drop it in a “drop-zone” of the client software. This page may or may not belong to a virtual store/Web page which participates in one of the Personal Affiliate Programs.

Composing a signature file:

Regarding the E-mail, “Signature” is a file which is attached to an E-mail document, and usually is displayed by E-mail programs as an integral part of the document. The majority of E-mail programs support signature files. A signature file may be an HTML file, MS Word document, TEXT file, BMP file and so forth.

According to a preferred embodiment of the invention, the signature file appears as follows:

<HTML>
<BODY>
<DIV ID=SEASAND_SIGNATURE>
<p><div align=“center”>
<table border=“1” width=“90%”>
<tr><td><table width=“90%”>
<tr align=“center” valign=“top”>
<td>
<a
href=“http://www.pwp.com/Redirector.dll?url=www.website1.
com/index.html,usr=1234”>
<img vspace=4 border=0 src=“Product1.jpg” width=“68”
height=“127” alt=“ ”>
</a><br>
</td>
<td>
<a
href=“http://www.pap.com/Redirector.dll?url=www.website2.
com/index.html,usr=1234”>
<img vspace=4 border=0 src=“Product2.jpg” width=“68”
height=“127” alt=“ ”>
</a><br>
</td>
</div>
</p>
</DIV>
</BODY>
</HTML>

Clicking on the relevant banner activates the file Redirectore.dll which resides in www.pap.com (the Personal Affiliate Program web site). The parameter for this program is www.website1.com/index.html, which is the URL (Uniform Resource Location, i.e. a file accessible on the Internet) where the PAP directs the browser upon click. The signature file contains also the ID of the Personal Affiliate in the Personal Affiliate Program, which in this example is 1234.

Client Software is a software by which the Personal Affiliate creates or edits signature files according to his preferences, such as format and selection of the affiliated virtual stores. The ID received during the registration procedure is attached to the signature file. The software allows creation of several signature files, from which the Personal Affiliate can select his signature.

Another purpose of the software is to store the links/banners of Web sites which may attached to the signature files he creates, as described in the Collecting the links/banners section.

E-commerce Activity:

There are two variations for e-commerce activity, according to whether the recipient participates in a Personal Affiliate Program or not. If the recipient is a Personal Affiliate, then the scenario is as follows:

Personal Affiliate: Attaches the recently created signature file to E-mail message he sends. The ID received in the registration procedure is embedded in the signature file.

Recipient: Receives an E-mail from the Personal Affiliate.

Recipient: Clicks on one or more of the web-links appearing on the E-mail, Due to this clicking, the Personal Affiliate Program (PAP) receives (via the Internet) a message which contains information such as the Affiliate's ID and the UTRL of the site to which he was directed.

Personal Affiliate Program Software: Redirects the recipient to the desired URL (‘Uniform Source Locator’, i.e. an address of a web site). However, from now on, the affiliate is the Personal Affiliate Program (PAP) rather than the original Personal Affiliate. That is the PAP's ID is considered rather then PA's

Recipient: Purchases a product.

Personal Affiliate Program Software: Credits the Affiliate's account, unless it operates according to a nonpersonal remuneration scheme,

Personal Affiliate: Receives report and a commission due to the purchase made by the recipient of his E-mail (or according to other remuneration schemes).

If the recipient is not a Personal Affiliate, still the originator Personal Affiliate will be remunerated, but this remuneration will be shared between other Personal Affiliates.

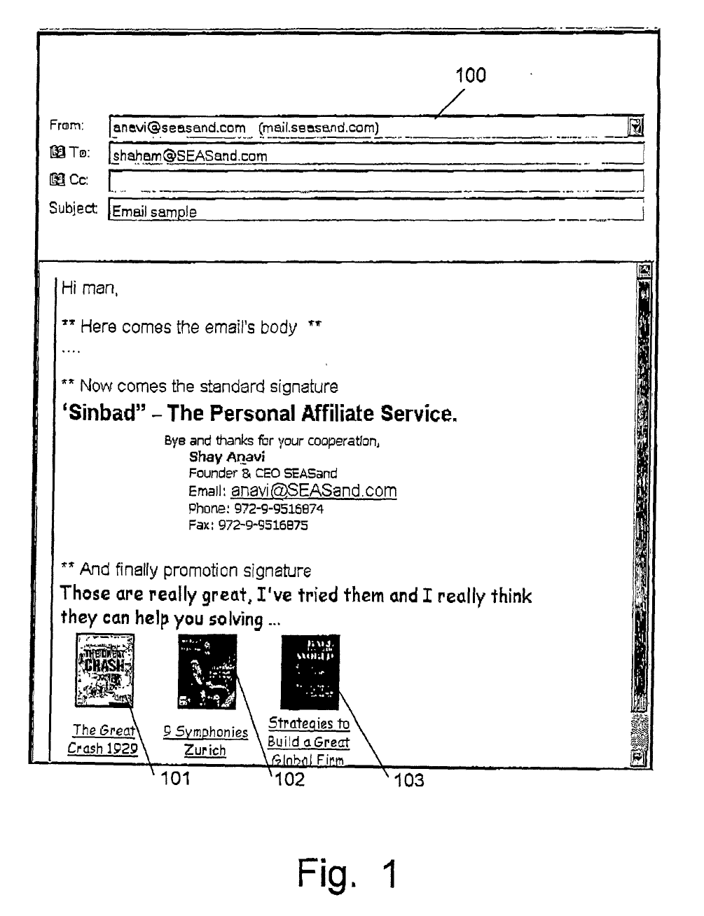

FIG. 1 shows an E-mail sent by a Personal Affiliate, according to a preferred embodiment of the invention. The signature file in this example contains three affiliated sites marked as 101, 102 and 103.

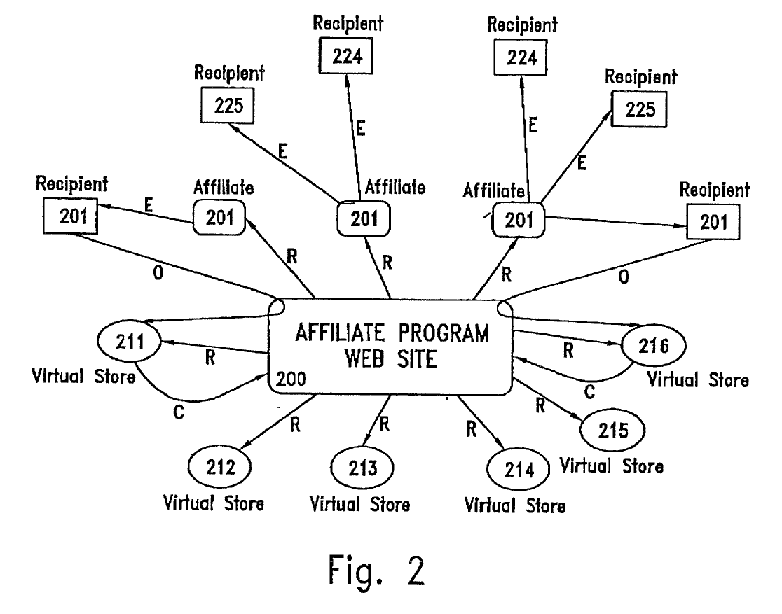

FIG. 2 schematically illustrates the activities performed on an affiliate program, according to a preferred embodiment of the invention. The arrows have the following meanings:

R—registration

E—e-mail

O—order

C—commission

All the virtual stores represented in this figure are participants in the Personal Affiliate Program.

Virtual store 211 registers to the affiliate program 200;

Affiliate 201 registers to the affiliate program 200 as well,

Affiliate 201 sends to recipient 221 an E-mail with the recently created signature file containing information and link of the affiliated virtual store 211;

Recipient 221 orders 242, a service from virtual store 211. The order details are registered in affiliate program 200;

Due to the purchase, virtual store 211 sends the commission 243 to the affiliate program, and then Affiliate 201 gets the reward from the affiliate program 200 (according to any remuneration scheme).

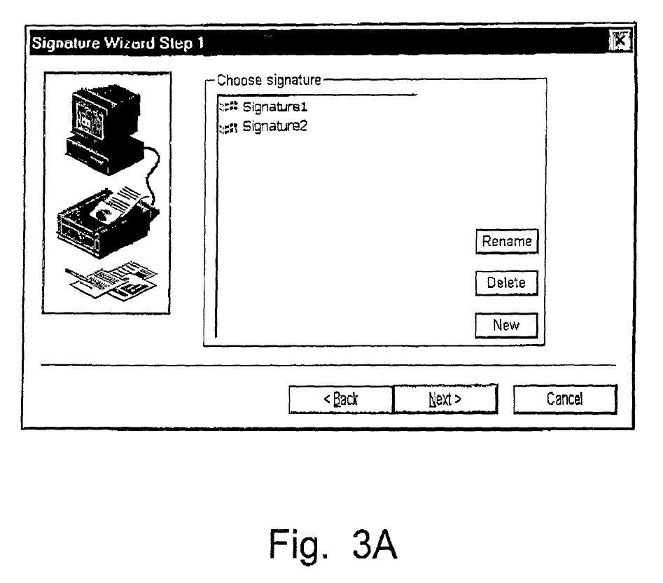

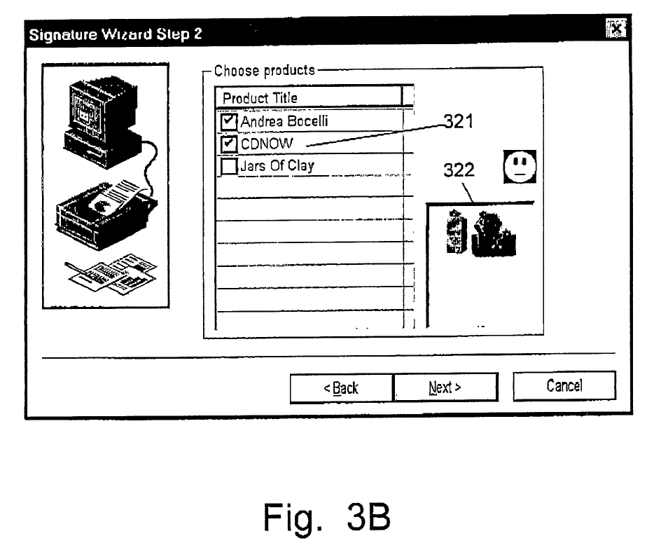

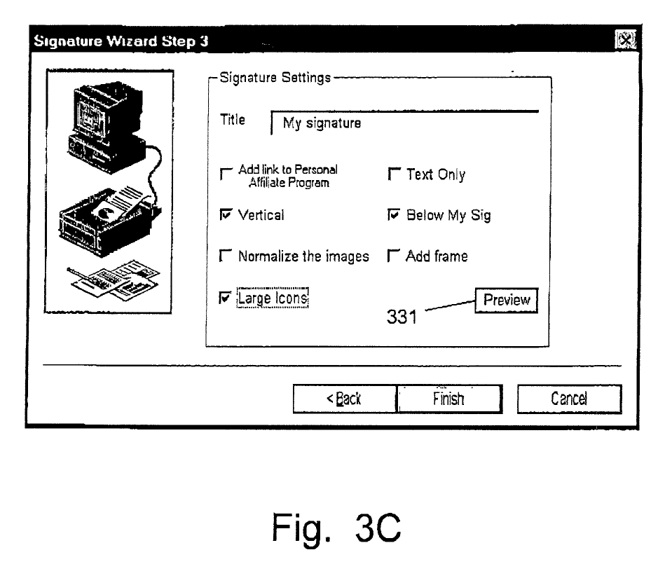

FIG. 3 illustrates the process of constructing a signature file using the agent software, according to a preferred embodiment of the invention,

In step 1, which is illustrated in FIG. 3.a, the user is given the choice of selecting an existing signature file (Signature 1 or Signature 2), renaming or deleting an existing signature file or creating a new signature file.

In step 2, illustrated in FIG. 3.b, the user is given the choice of selecting the virtual-stores/web-sites/products/web-pages to be included in the selected signature file. The user clicks on selection boxes 321. For illustrative purposes of the program, the icons of the selected items are inserted into box 322.

In step 3, illustrated in FIG. 3.c, the user is given the choice of selecting the style of the signature. At this stage, the user may view the signature by clicking the preview button 331.

There are a plurality of ways to remunerate the Personal Affiliate, such as commission, reduction on products purchased, participation in lottery with each purchase or even as a remuneration for browsing virtual stores, fixed fee, etc.

While embodiments of the invention have been described by way of illustration, it will be understood that the invention can be carried out by persons skilled in the art with many modifications, variations and adaptations, without departing from its spirit or exceeding the scope of the claims.

1. A method for effecting affiliate e-commerce, comprising:
providing at least one virtual store interested in promoting products or services or web-pages via an affiliate method;
providing a plurality of affiliates, having access to an e-mail system, with an agent software which adds promotional material relating to said virtual stores to their e-mail signature, or appends such material to outgoing E-mail messages generated by them;
providing link information in said promotional material, to a joint web server suitable to redirect a web surfer from it to one or more web pages;
providing information in said promotional material, suitable to identify the affiliate who has disseminated it;
when a remuneration is received from a virtual store for a referral, crediting a portion of such remuneration to one or more of said affiliates,

2. A method according to claim 1, wherein the joint web server is registered as an affiliate in another joint web server connected to at least another different virtual store.

3. A method according to claim 1, wherein the affiliates are rewarded according to the purchase and/or according to the times the recipients entered to online stores due to the e-mail received from said affiliates.

4. A method according to claim 1, wherein the affiliates are rewarded in a manner selected from fixed and/or differential payments, discount on purchase of goods or services, or coupons for participation in a lottery.

5. A method according to claim 1, wherein the virtual stores are web sites.

6. A method according to claim 5, wherein the web sites provide one or more services selected from the group:
web sites that sell goods
web sites that promote ideas and/or nominees
web sites that provide advertising information

7. A system for effecting affiliate e-commerce, comprising:
at least one joint web server which is affiliated with one or more sites engaging in e-commerce;
one or more affiliates having a client software installed, such that promotional material is added to their e-mail signature, said promotional information comprising data relative to the virtual store and link information suitable to direct any person from said promotional information to said joint web server; and
at least one virtual store providing said promotional material.

8. A system according to claim 7, wherein the promotional information comprises one or more image(s), and/or one or more web link(s).

9. A method for effecting affiliate e-commerce, substantially as described and illustrated.

10. A system for effecting affiliate e-commerce, substantially as described and illustrated.
